(19) United States
(12) Patent Application Publication
(10) Pub. No.: US 2026/0125522 A1
(43) Pub. Date: May 7, 2026

(54) NANOCAPSULE-BASED THERMAL INSULATION FUNCTIONAL MASTERBATCH AND PREPARATION METHOD THEREOF

(71) Applicant: SHANGHAI HUZHENG INDUSTRY CO., LTD, Shanghai (CN)

(72) Inventors: Jiayi LI, Shanghai (CN); Jiaxiao XUE, Shanghai (CN)

(73) Assignee: SHANGHAI HUZHENG INDUSTRY CO., LTD, Shanghai, MH (CN)

(21) Appl. No.: 18/868,160

(22) PCT Filed: Apr. 15, 2024
(86) PCT No.: PCT/CN2024/087661

§ 371 Date: Nov. 21, 2024

(30) Foreign Application Priority Data
Jan. 10, 2024 (CN) 202410033638.9

(51) Int. Cl. C08J 3/22; B82Y 30/00; B82Y 40/00; C08J 5/18; C08K 3/22

(52) U.S. Cl. CPC C08J 3/226; B82Y 30/00; B82Y 40/00; C08J 5/18; C08K 3/22; C08J 2333/12; C08K 2003/2258

(57) ABSTRACT

A nanocapsule-based thermal insulation functional masterbatch and a preparation method thereof are provided. The nanocapsule-based thermal insulation functional masterbatch is prepared by mixing a polymer substrate, an organic-inorganic composite nanocapsule, and an auxiliary agent to allow granulation, where the nanocapsule is added at 1 wt % to 20 wt % and the auxiliary agent is added at 0.2 wt % to 0.5 wt % by weight percentage, while the polymer substrate is added as a balance. The nanocapsule is prepared by emulsification prepolymerization, polymerization, and nano-compounding. Compared with general thermal insulation functional masterbatch, the nanocapsule-based thermal insulation functional masterbatch shows outstanding stability, higher thermal insulation, and excellent thermal insulation performance.

The present application claims priority to Chinese Patent Application No. CN202410033638.9 filed to the China National Intellectual Property Administration (CNIPA) on Jan. 10, 2024 and entitled “NANOCAPSULE-BASED THERMAL INSULATION FUNCTIONAL MASTERBATCH AND PREPARATION METHOD THEREOF”, which is incorporated herein by reference in its entirety.

### TECHNICAL FIELD

The present disclosure relates to the technical field of nanomaterials, and in particular to a nanocapsule-based thermal insulation functional masterbatch and a preparation method thereof.

### BACKGROUND

Thermal insulation functional masterbatch can be used to prepare thermal insulation functional films, sheets and other plastic materials, and plays an important role in many fields such as construction and automobiles. General thermal insulation functional masterbatch only shows simple thermal insulation function, and there is still much room for improvement in thermal insulation, energy storage, and heat preservation.

Chinese patent CN114752142B has disclosed a transparent thermal insulation masterbatch based on a cesium tungsten oxide system. By modifying a nano-cesium tungsten oxide to form a polymer segment containing ester bonds, a HALS-g-EVA/PVB-g-Cs0.33WO₃ composite is obtained through ester exchange, thus achieving thermal insulation and blue light protection functions. Based on a general inorganic thermal insulation masterbatch, aging resistance and blue light protection are improved through modified compounding while the thermal insulation performance is not improved on the transparent thermal insulation masterbatch. Chinese patent CN108530843B has announced a thermal insulation masterbatch for BOPET window film. A thermal insulation material is a composition with a core-inner shell-outer shell structure that is composed of nanoscale carbonized cellulose, titanium dioxide, and polyacrylamide, achieving thermal insulation function through heat absorption of the inner core and reflectivity of the inner shell. However, the above thermal insulation masterbatch is mainly used in the BOPET window film, and no further improvement is made in terms of thermal insulation and other functionalities.

### SUMMARY

In view of the above-mentioned deficiencies in the prior art, according to the examples of the present disclosure, it is hoped to provide a functional masterbatch with high-efficiency and long-term thermal insulation, energy storage, and heat preservation functions, so as to achieve the improvement of functionality and the expansion of applications.

According to an example, the present disclosure provides a nanocapsule-based thermal insulation functional masterbatch, where the nanocapsule-based thermal insulation functional masterbatch is prepared by mixing a plastic substrate, a nanocapsule, and an auxiliary agent to allow granulation, the nanocapsule is added at 1 wt % to 20 wt % of the nanocapsule-based thermal insulation functional masterbatch, and the auxiliary agent is added at 0.2 wt % to 0.5 wt % of the nanocapsule-based thermal insulation functional masterbatch. The plastic substrate is selected from the group consisting of polyethylene (PE), polypropylene (PP), polyvinyl chloride (PVC), polymethyl methacrylate (PMMA), polyethylene terephthalate (PETTA), polystyrene (PS), and polycarbonate (PC). The nanocapsule is a nanoscale thermal insulation material formed by organically compounding a nanoscale tungsten-doped oxide and an alcohol-acid composite crystal. The auxiliary agent is a complex of ethylene glycol polyoxyethylene ether, γ-aminopropyl triethoxysilane, and pentaerythritol tetrakis(3-(3,5-di-tert-butyl-4-hydroxyphenyl) propionate).

According to an example, a preparation method of the nanocapsule includes the following steps:
(1) according to parts by mass, dissolving 0.5 parts to 1 part of sodium dodecyl sulfate (SDS) in 50 parts to 80 parts of deionized water to obtain a solution A; mixing 5 parts to 8 parts of methyl methacrylate (MMA), 1 part to 2 parts of ethyl acrylate (EA), 8 parts to 15 parts of the alcohol-acid composite crystal, and 0.1 parts to 0.2 parts of azobisisobutyronitrile (AIBN) ultrasonically for 5 min to 10 min to obtain a solution B; adding the solution B dropwise into the solution A, and then stirring at 20° C. to 40° C. for 5 min to 30 min to obtain an emulsion C; and stirring the emulsion C to allow a reaction at 75° C. to 85° C. for 0.5 h to 1.5 h;
(2) dissolving 1 part to 2 parts of the SDS and 1 part to 5 parts of hydroxyethyl methacrylate (HEMA) in 120 parts to 150 parts of the deionized water to obtain a solution D; mixing 7 parts to 10 parts of the MMA, 2 parts to 3 parts of pentaerythritol tetraacrylate (PETTA), and 0.1 parts to 0.3 parts of the AIBN ultrasonically to allow dispersion for 5 min to 15 min to obtain a solution E; adding the solution E dropwise into the solution D, and then stirring at 20° C. to 40° C. for 5 min to 30 min to obtain an emulsion F; and adding the emulsion F into the emulsion C, and then conducting a reaction at 75° C. to 85° C. for 5 h to 10 h to obtain a polymer solution;
(3) dispersing 5 parts to 10 parts of the nanoscale tungsten-doped oxide and 0.1 parts to 0.5 parts of polyvinylpyrrolidone (PVP) in 50 parts to 100 parts of the deionized water, adjusting an obtained solution to a pH value of 5.5 to 6.5 with hydrochloric acid, conducting an ultrasonic treatment for 0.5 h to 1 h, and then conducting washing, filtering, and drying; mixing an obtained dried material and 1 part to 2 parts of the SDS in 30 parts to 50 parts of the deionized water, and then conducting an ultrasonic treatment for 10 min to 30 min to obtain a dispersion G; and adding the dispersion G dropwise into the polymer solution obtained in step (2), and then stirring until a uniform liquid phase is formed; and
(4) adding 2 parts to 5 parts of a silane emulsion into the uniform liquid phase obtained in step (3), stirring to allow a reaction at 40° C. to 50° C. for 1 h to 2 h, and then subjecting an obtained reaction solution to suction filtration, repeated washing, and vacuum drying for 24 h to 48 h to obtain the nanocapsule.

According to an example, the alcohol-acid composite crystal in step (1) is one selected from the group consisting of a lauric acid/tetradecanol composite crystal and a tetradecanoic acid/heptadecanol composite crystal, has an alcohol-to-acid molar ratio of 1:1, and is prepared by co-melting recrystallization.

According to an example, the adding dropwise in steps (1) and (2) is conducted at 1 mL/min to 3 mL/min.

According to an example, the adding dropwise in step (3) is conducted at 3 mL/min to 5 mL/min.

According to an example, the silane emulsion in step (4) is prepared by uniformly mixing Tween-40, KH-460, and deionized water at a mass ratio of 3:50:80.

Technical effect: the thermal insulation material and the energy storage material in the present disclosure are efficiently and stably compounded in the form of nanocapsule to achieve higher thermal insulation and heat preservation properties, as well as material stability. Specifically, the nanocapsule is prepared by emulsion polymerization of an alcohol-acid composite crystal and an acrylic monomer. The alcohol-acid composite crystal is gradually covered by a shell layer mainly composed of MMA during the polymerization. PETTA is introduced as a cross-linking agent of the shell of the nanocapsule to achieve reliability and stability of the shell; EA is introduced to adjust the flexibility of the shell. In addition, a monomer HEMA is additionally introduced as an active site for further compounding. At the same time, a surface of the nanoscale tungsten-doped oxide is activated and then compounded with the shell of the nanocapsule having active sites via a coupling agent. The main features are better thermal insulation and heat preservation, as well as outstanding stability.

Compared with the prior art, the subsequent examples and test examples will demonstrate that the nanocapsule-based thermal insulation functional masterbatch disclosed in the present disclosure has the following advantages: outstanding thermal insulation performance, desirable stability, and high transparency and clarity when preparing films, thus exhibiting a great application value in the field of energy-saving thermal insulation materials.

In the present disclosure, the functionality of the thermal insulation masterbatch is improved. The thermal insulation and energy storage materials are stably and effectively combined in the form of microcapsule, which not only increases an upper limit of thermal insulation capacity by absorbing heat, but also achieves energy storage and thermal insulation performance. At a time when energy conservation and emission reduction are increasingly required, the thermal insulation functional masterbatch of the present disclosure plays an important role in promoting social and economic development.

### DETAILED DESCRIPTION OF THE EMBODIMENTS

The present application will be further described below in conjunction with specific examples. It should be understood that these examples are merely intended to describe the present application, rather than to limit the scope of the present application. After reading the content of the present disclosure, technicians can make various changes or modifications to the present disclosure, and these equivalent changes and modifications also fall within the scope defined by the claims of the present disclosure.

In the present disclosure, the nanoscale tungsten-doped oxide is a GTO product produced by Shanghai Huzheng Industrial Co., Ltd., code-named G-P100. The other raw materials used in the following examples are commercially available products unless otherwise specified.

### Example 1 Nanocapsule was Prepared by the Following Steps

(1) 6 g of SDS was dissolved in 750 g of deionized water to obtain a solution A; 50 g of MMA, 10 g of EA, 100 g of a lauric acid/tetradecanol composite crystal (with an alcohol-to-acid molar ratio of 1:1), and 1 g of AIBN were ultrasonically mixed for 10 min to obtain a solution B. The solution B was added dropwise into the solution A at 2 mL/min, and then stirred at 40° C. for 20 min to obtain an emulsion C, and the emulsion C was stirred to allow reaction at 75° C. for 1 h.
(2) 10 g of SDS and 30 g of HEMA were dissolved in 1,200 g of deionized water to obtain a solution D; 70 g of MMA, 20 g of PETTA, and 1 g of AIBN were mixed ultrasonically to allow dispersion for 10 min to obtain a solution E; the solution E was added dropwise into the solution D at 2 mL/min, and then stirred at 40° C. for 30 min to obtain an emulsion F; and the emulsion F was added into the emulsion C, and then a reaction was conducted at 75° C. for 7 h to obtain a polymer solution.
(3) 80 g of a nanoscale tungsten-doped oxide G-P100 and 2 g of PVP were dissolved in 800 g of deionized water, an obtained solution was adjusted to a pH value of 6.0 with hydrochloric acid, an ultrasonic treatment was conducted for 0.5 h, and then washing, filtering, and drying were conducted; an obtained dried material and 10 g of SDS were mixed in 300 g of deionized water, and then an ultrasonic treatment was conducted for 10 min to obtain a dispersion G; and the dispersion G was added dropwise into the polymer solution at 3 mL/min, and then stirred until a uniform liquid phase was formed.
(4) Tween-40, KH-460, and deionized water were mixed at a mass ratio of 3:50:80 to form a silane emulsion, 30 g of the silane emulsion was added into the uniform liquid phase, and a resulting mixture was stirred to allow reaction at 40° C. for 2 h; an obtained reaction solution was subjected to suction filtration, repeated washing 3 times, and vacuum drying for 48 h to obtain the nanocapsule.
100 g of the nanocapsule, 897 g of PET plastic chips, 0.8 g of ethylene glycol polyoxyethylene ether, 1.2 g of pentaerythritol tetrakis(3-(3,5-di-tert-butyl-4-hydroxyphenyl) propionate), and 1 g of γ-aminopropyl triethoxysilane were added into a plastic granulator under sufficient stirring to obtain a nanocapsule-based thermal insulation functional masterbatch.

### Example 2 Nanocapsule was Prepared by the Following Steps

(1) 5 g of SDS was dissolved in 800 g of deionized water to obtain a solution A; 60 g of MMA, 15 g of EA, 12 g of a tetradecanoic acid/heptadecanol composite crystal (with an alcohol-to-acid molar ratio of 1:1), and 1 g of AIBN were ultrasonically mixed for 10 min to obtain a solution B; the solution B was added dropwise into the solution A at 3 mL/min, and then stirred at 40° C. for 30 min to obtain an emulsion C; the emulsion C was stirred to allow reaction at 75° C. for 1 h.
(2) 10 g of SDS and 35 g of HEMA were dissolved in 1,500 g of deionized water to obtain a solution D; 80 g of MMA, 30 g of PETTA, and 1.5 g of AIBN were mixed ultrasonically to allow dispersion for 15 min to obtain a solution E; the solution E was added dropwise into the solution D at 3 mL/min, and then stirred at 40° C. for 30 min to obtain an emulsion F; and the emulsion F was added into the emulsion C, and then a reaction was conducted at 80° C. for 9 h to obtain a polymer solution.
(3) 90 g of a nanoscale tungsten-doped oxide G-P100 and 3 g of PVP were dissolved in 1,000 g of deionized water, an obtained solution was adjusted to a pH value of 5.5 with hydrochloric acid, an ultrasonic treatment was conducted for 1 h, and then washing, filtering, and drying were conducted; an obtained dried material and 15 g of SDS were mixed in 400 g of deionized water, and then an ultrasonic treatment was conducted for 30 min to obtain a dispersion G; and the dispersion G was added dropwise into the polymer solution at 4 mL/min, and then stirred until a uniform liquid phase was formed.
(4) Tween-40, KH-460, and deionized water were mixed at a mass ratio of 3:50:80 to form a silane emulsion, 35 g of the silane emulsion was added into the uniform liquid phase, and a resulting mixture was stirred to allow reaction at 45° C. for 2 h; an obtained reaction solution was subjected to suction filtration, repeated washing 3 times, and vacuum drying for 48 h to obtain the nanocapsule.
100 g of the nanocapsule, 897 g of PP plastic chips, 0.7 g of ethylene glycol polyoxyethylene ether, 1.5 g of pentaerythritol tetrakis(3-(3,5-di-tert-butyl-4-hydroxyphenyl) propionate), and 1 g of γ-aminopropyl triethoxysilane were added into a plastic granulator under sufficient stirring to obtain a nanocapsule-based thermal insulation functional masterbatch.

### Example 3 Nanocapsule was Prepared by the Following Steps

(1) 6 g of SDS was dissolved in 800 g of deionized water to obtain a solution A; 65 g of MMA, 15 g of EA, 14 g of a tetradecanoic acid/heptadecanol composite crystal (with an alcohol-to-acid molar ratio of 1:1), and 1 g of AIBN were ultrasonically mixed for 10 min to obtain a solution B; the solution B was added dropwise into the solution A at 3 mL/min, and then stirred at 40° C. for 30 min to obtain an emulsion C; the emulsion C was stirred to allow reaction at 75° C. for 1 h.
(2) 10 g of SDS and 40 g of HEMA were dissolved in 1,500 g of deionized water to obtain a solution D; 80 g of MMA, 30 g of PETTA, and 1.5 g of AIBN were mixed ultrasonically to allow dispersion for 15 min to obtain a solution E; the solution E was added dropwise into the solution D at 3 mL/min, and then stirred at 40° C. for 30 min to obtain an emulsion F; and the emulsion F was added into the emulsion C, and then a reaction was conducted at 80° C. for 8 h to obtain a polymer solution.
(3) 80 g of a nanoscale tungsten-doped oxide G-P100 and 2 g of PVP were dissolved in 1,000 g of deionized water, an obtained solution was adjusted to a pH value of 6.0 with hydrochloric acid, an ultrasonic treatment was conducted for 1 h, and then washing, filtering, and drying were conducted; an obtained dried material and 12 g of SDS were mixed in 400 g of deionized water, and then an ultrasonic treatment was conducted for 30 min to obtain a dispersion G; and the dispersion G was added dropwise into the polymer solution at 4 mL/min, and then stirred until a uniform liquid phase was formed.
(4) Tween-40, KH-460, and deionized water were mixed at a mass ratio of 3:50:80 to form a silane emulsion, 35 g of the silane emulsion was added into the uniform liquid phase, and a resulting mixture was stirred to allow reaction at 45° C. for 2 h; an obtained reaction solution was subjected to suction filtration, repeated washing 3 times, and vacuum drying for 48 h to obtain the nanocapsule.
100 g of the nanocapsule, 897 g of PMMA plastic chips, 0.7 g of ethylene glycol polyoxyethylene ether, 1.5 g of pentaerythritol tetrakis(3-(3,5-di-tert-butyl-4-hydroxyphenyl) propionate), and 1 g of γ-aminopropyl triethoxysilane were added into a plastic granulator under sufficient stirring to obtain a nanocapsule-based thermal insulation functional masterbatch.

### Comparative Example A Nanoscale Thermal Insulation Material was Prepared by the Following Steps

(1) 6 g of SDS was dissolved in 800 g of deionized water to obtain a solution A; 65 g of MMA, 15 g of EA, 14 g of a lauric acid/tetradecanol composite crystal (with an alcohol-to-acid molar ratio of 1:1), and 1 g of AIBN were ultrasonically mixed for 10 min to obtain a solution B; the solution B was added dropwise into the solution A at 3 mL/min, and then stirred at 40° C. for 30 min to obtain an emulsion C; the emulsion C was stirred to allow reaction at 75° C. for 1 h.
(2) 10 g of SDS and 40 g of HEMA were dissolved in 1,500 g of deionized water to obtain a solution D; 80 g of MMA, 30 g of PETTA, and 1.5 g of AIBN were mixed ultrasonically to allow dispersion for 15 min to obtain a solution E; the solution E was added dropwise into the solution D at 3 mL/min, and then stirred at 40° C. for 30 min to obtain an emulsion F; and the emulsion F was added into the emulsion C, and then a reaction was conducted at 80° C. for 8 h to obtain a polymer solution.
(3) 80 g of a nanoscale tungsten-doped oxide G-P100 was added into the polymer solution, mixed until homogeneous, a resulting reaction solution was subjected to suction filtration, repeated washing 3 times, and vacuum drying for 48 h to obtain the nanoscale thermal insulation material.
100 g of nanoscale thermal insulation material, 897 g of PMMA plastic chips, 0.7 g of ethylene glycol polyoxyethylene ether, 1.5 g of pentaerythritol tetrakis(3-(3,5-di-tert-butyl-4-hydroxyphenyl) propionate), and 1 g of γ-aminopropyl triethoxysilane were added into a plastic granulator under sufficient stirring to obtain a control thermal insulation functional masterbatch.

Test Example The nanocapsule-based thermal insulation functional masterbatch prepared in each example was co-blended and extruded with the corresponding substrate masterbatch at a mass percentage of 5%, and a film with a thickness of 50 μm was prepared by a biaxial stretching process, and its performance was tested. The infrared blocking rate and visible light transmittance of the film were tested by spectrophotometer and optical transmittance meter, respectively. The infrared blocking rate test wavebands were 950 nm and 1400 nm.

The weather resistance test was conducted according to the ASTM-D4329-13 artificial accelerated weather resistance test method. The clarity (haze) was tested by a haze tester. Test results were shown in Table 1. The prepared film had desirable visible light transmittance and showed high thermal insulation effect, with a barrier rate reaching 99.9%. The thermal insulation performance was extremely outstanding, which was significantly improved compared with general thermal insulation films. At the same time, the film also exhibited excellent aging resistance and had passed the QUV5000 h test, demonstrating outstanding weather resistance. In terms of clarity, the haze of the film was less than 0.5%, showing high clarity. The comparative example used a similar nanoscale thermal insulation material, and the nanoscale non-doped oxide was not further modified and effectively composited with the nanocapsule, resulting in particle phase separation and easy migration. The comparative example had obvious problems in compatibility. Although there was no obvious impact on visible light transmittance and infrared blocking rate, the uniformity and compatibility were obviously inferior to those of the examples in terms of weather resistance, such that fogging occurred after QUV5000 h. The above tests showed that the functional film prepared from the nanocapsule-based thermal insulation functional masterbatch of each example had desirable transparency and clarity, outstanding stability, and excellent thermal insulation, and showed an important application value in the field of thermal insulation and energy saving.

TABLE 1
Performance test of film prepared from nanocapsule-
based thermal insulation functional masterbatch

| | Visible light | Infrared blocking rate | | QUV | |
|---|---|---|---|---|---|
| Sample | transmittance | 950 nm | 1400 nm | 5000 h | Haze |
| Example 1 | 73% | 99.5% | 99.0% | No change | 0.3% |
| Example 2 | 72% | 99.9% | 99.3% | No change | 0.3% |
| Example 3 | 72% | 99.6% | 99.3% | No change | 0.3% |
| Comparative | 70% | 99.0% | 98.5% | Fogging | 0.4% |
| Example | | | | | |

The foregoing is a further detailed description of the present disclosure in connection with specific examples, and it is not to be determined that the specific implementation of the present disclosure is limited to these illustrations. It will be apparent to those skilled in the art that certain simple modifications or substitutions may be made without departing from the spirit of the present disclosure, and all such modifications or substitutions are intended to be within the protection scope of the present disclosure.

1. A nanocapsule, wherein the nanocapsule is a nanoscale thermal insulation material formed by organically compounding a nanoscale tungsten-doped oxide and an alcohol-acid composite crystal; and
a preparation method of the nanocapsule comprises the following steps:
(1) according to parts by mass, dissolving 0.5 parts to 1 part of sodium dodecyl sulfate (SDS) in 50 parts to 80 parts of deionized water to obtain a solution A; mixing 5 parts to 8 parts of methyl methacrylate (MMA), 1 part to 2 parts of ethyl acrylate (EA), 8 parts to 15 parts of the alcohol-acid composite crystal, and 0.1 parts to 0.2 parts of azobisisobutyronitrile (AIBN) ultrasonically for 5 min to 10 min to obtain a solution B; adding the solution B dropwise into the solution A, and then stirring at 20° C. to 40° C. for 5 min to 30 min to obtain an emulsion C; and stirring the emulsion C to allow a reaction at 75° C. to 85° C. for 0.5 h to 1.5 h;
(2) dissolving 1 part to 2 parts of the SDS and 1 part to 5 parts of hydroxyethyl methacrylate (HEMA) in 120 parts to 150 parts of the deionized water to obtain a solution D; mixing 7 parts to 10 parts of the MMA, 2 parts to 3 parts of pentaerythritol tetraacrylate (PETTA), and 0.1 parts to 0.3 parts of the AIBN ultrasonically to allow dispersion for 5 min to 15 min to obtain a solution E; adding the solution E dropwise into the solution D, and then stirring at 20° C. to 40° C. for 5 min to 30 min to obtain an emulsion F; and adding the emulsion F into the emulsion C, and then conducting a reaction at 75° C. to 85° C. for 5 h to 10 h to obtain a polymer solution;
(3) dispersing 5 parts to 10 parts of the nanoscale tungsten-doped oxide and 0.1 parts to 0.5 parts of polyvinylpyrrolidone (PVP) in 50 parts to 100 parts of the deionized water, adjusting an obtained solution to a pH value of 5.5 to 6.5 with hydrochloric acid, conducting an ultrasonic treatment for 0.5 h to 1 h, and then conducting washing, filtering, and drying; mixing an obtained dried material and 1 part to 2 parts of the SDS in 30 parts to 50 parts of the deionized water, and then conducting an ultrasonic treatment for 10 min to 30 min to obtain a dispersion G; and adding the dispersion G dropwise into the polymer solution obtained in step (2), and then stirring until a uniform liquid phase is formed; and
(4) adding 2 parts to 5 parts of a silane emulsion into the uniform liquid phase obtained in step (3), stirring to allow a reaction at 40° C. to 50° C. for 1 h to 2 h, and then subjecting an obtained reaction solution to suction filtration, repeated washing, and vacuum drying for 24 h to 48 h to obtain the nanocapsule.

2. A nanocapsule-based thermal insulation functional masterbatch, wherein the nanocapsule-based thermal insulation functional masterbatch is prepared by mixing a plastic substrate, the nanocapsule according to claim 1, and an auxiliary agent to allow granulation, the nanocapsule is added at 1 wt % to 20 wt % of the nanocapsule-based thermal insulation functional masterbatch, and the auxiliary agent is added at 0.2 wt % to 0.5 wt % of the nanocapsule-based thermal insulation functional masterbatch.

3. The nanocapsule-based thermal insulation functional masterbatch according to claim 2, wherein the alcohol-acid composite crystal in step (1) is one selected from the group consisting of a lauric acid/tetradecanol composite crystal and a tetradecanoic acid/heptadecanol composite crystal, has an alcohol-to-acid molar ratio of 1:1, and is prepared by co-melting recrystallization.

4. The nanocapsule-based thermal insulation functional masterbatch according to claim 2, wherein the adding dropwise in steps (1) and (2) is conducted at 1 mL/min to 3 mL/min.

5. The nanocapsule-based thermal insulation functional masterbatch according to claim 2, wherein the adding dropwise in step (3) is conducted at 3 mL/min to 5 mL/min.

6. The nanocapsule-based thermal insulation functional masterbatch according to claim 2, wherein the silane emulsion in step (4) is prepared by uniformly mixing Tween-40, KH-460, and deionized water at a mass ratio of 3:50:80.

7. The nanocapsule-based thermal insulation functional masterbatch according to claim 2, wherein the plastic substrate is selected from the group consisting of polyethylene (PE), polypropylene (PP), polyvinyl chloride (PVC), polymethyl methacrylate (PMMA), polyethylene terephthalate (PETTA), polystyrene (PS), and polycarbonate (PC).

8. The nanocapsule-based thermal insulation functional masterbatch according to claim 2, wherein the auxiliary agent is a complex of ethylene glycol polyoxyethylene ether, γ-aminopropyl triethoxysilane, and pentaerythritol tetrakis(3-(3,5-di-tert-butyl-4-hydroxyphenyl) propionate).

9. The nanocapsule-based thermal insulation functional masterbatch according to claim 2, wherein the nanocapsule is added at 10 wt % of the nanocapsule-based thermal insulation functional masterbatch.

10. A thermal insulation functional film, comprising the following raw materials by mass fraction: 5% of the nanocapsule-based thermal insulation functional masterbatch according to claim 2 and a substrate masterbatch as a balance.

11. The nanocapsule-based thermal insulation functional masterbatch according to claim 7, wherein the auxiliary agent is a complex of ethylene glycol polyoxyethylene ether, γ-aminopropyl triethoxysilane, and pentaerythritol tetrakis(3-(3,5-di-tert-butyl-4-hydroxyphenyl) propionate).

12. The thermal insulation functional film according to claim 10, wherein the alcohol-acid composite crystal in step (1) is one selected from the group consisting of a lauric acid/tetradecanol composite crystal and a tetradecanoic acid/heptadecanol composite crystal, has an alcohol-to-acid molar ratio of 1:1, and is prepared by co-melting recrystallization.

13. The thermal insulation functional film according to claim 10, wherein the adding dropwise in steps (1) and (2) is conducted at 1 mL/min to 3 mL/min.

14. The thermal insulation functional film according to claim 10, wherein the adding dropwise in step (3) is conducted at 3 mL/min to 5 mL/min.

15. The thermal insulation functional film according to claim 10, wherein the silane emulsion in step (4) is prepared by uniformly mixing Tween-40, KH-460, and deionized water at a mass ratio of 3:50:80.

16. The thermal insulation functional film according to claim 10, wherein the plastic substrate is selected from the group consisting of polyethylene (PE), polypropylene (PP), polyvinyl chloride (PVC), polymethyl methacrylate (PMMA), polyethylene terephthalate (PETTA), polystyrene (PS), and polycarbonate (PC).

17. The thermal insulation functional film according to claim 10, wherein the auxiliary agent is a complex of ethylene glycol polyoxyethylene ether, γ-aminopropyl triethoxysilane, and pentaerythritol tetrakis(3-(3,5-di-tert-butyl-4-hydroxyphenyl) propionate).

18. The thermal insulation functional film according to claim 10, wherein the nanocapsule is added at 10 wt % of the nanocapsule-based thermal insulation functional masterbatch.
